(19) United States
(12) Patent Application Publication
(10) Pub. No.: US 2025/0236020 A1
(43) Pub. Date: Jul. 24, 2025

(54) AUTOMATIC ROBOT CALIBRATION FOR MULTI-JOINT ROBOTS

(71) Applicant: Applied Materials, Inc., Santa Clara, CA (US)

(72) Inventors: Ho Yu, Cupertino, CA (US); Paul Z. Wirth, Kalispell, MT (US); Damon K. Cox, Jarrell, TX (US); Mohsin Waqar, Oakland, CA (US); Jeffrey C. Hudgens, San Francisco, CA (US)

(21) Appl. No.: 18/421,937

(22) Filed: Jan. 24, 2024

(51) Int. Cl. B25J 9/16; B25J 11/00; B25J 13/08; B25J 21/00

(52) U.S. Cl. CPC B25J 9/1692; B25J 11/0095; B25J 13/088; B25J 21/00

(57) ABSTRACT

A system includes a chamber, a robot within the chamber, the robot including a plurality of links. The system further includes a vertically oriented sensor within the chamber, the vertically oriented sensor to detect a presence of one or more of the plurality of links. The system further includes a controller, to perform for each link to cause the robot to move the link through a field of view of the vertically oriented sensor. The controller further determines a zero horizontal position for the link based on the position of the link at which the link was detected by the vertically oriented sensor. The controller further automatically calibrates the robot within the chamber based on the zero horizontal position determined for each of the plurality of links.

### TECHNICAL FIELD

Embodiments of the present disclosure relate to systems and methods for improved joint coordinate teaching accuracy of robots.

### BACKGROUND

In the domain of semiconductor manufacturing systems and other substrate processing systems, precision and reliability have a direct impact on the quality of the products developed in the system. Components can be transferred between multiple process, transfer, and load lock chambers. Manufacturing systems also include a factory interface and storage areas (e.g., front opening unified pods (FOUPs)). Manufacturing systems employ articulated robots or multi-arm robots, which may be housed within the transfer chamber to transport substrates between the various process chambers and load lock chambers and are housed within the factory interface to transport substrates between the storage areas and the load lock chambers. For example, the robots transport substrates from chamber to chamber, from load lock chambers to process chambers, from process chambers to load lock chambers, from load lock chambers to storage areas, and/or from storage areas to load lock chambers. Calibration of transfer chamber robots is performed manually by personnel and is a slow and laborious process. Additionally, to perform manual calibration of the robot, the transfer chamber is opened up to atmosphere, and a person accesses an interior of the transfer chamber. This can prolong a downtime of the transfer chamber and can be a source of contamination for the transfer chamber.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a system includes a chamber, and a robot disposed within the chamber, the robot including a plurality of links. The system further includes a vertically oriented sensor within the chamber, the vertically oriented sensor to detect a presence of one or more of the plurality of links. The vertically oriented sensor may be an “auto teach” sensor, used to automatically calibrate one or more links of the robot. The system further includes a controller to for each link of the plurality of links, to cause the robot to move the link through a field of view of the vertically oriented sensor. The controller of the system further determines a zero horizontal position of the link based in a position of the link at which the link was detected by the vertically oriented sensor (e.g., auto teach sensor). The controller of the system further automatically calibrates the robot within the chamber based on the zero horizontal position determined for each of the plurality of links.

In another aspect of the disclosure, a system includes a chamber, and a robot within the chamber, the robot including a plurality of links and one or more end effectors. The system further includes a horizontally oriented sensor configured to detect a presence of the one or more end effectors. The horizontally oriented sensor may be an “auto teach” sensor, used to automatically calibrate one or more end effectors of the robot. The system further includes a controller to, for each end effector of the one or more end effectors, cause the robot to extend the end effector. The controller of the system further causes the robot to move vertically to cause the extended end effector to move through a field of view of the horizontally oriented sensor (e.g., second auto teach sensor). The controller of the system further determines a zero vertical position for the end effector based on a vertical position of the robot at which the end effector was detected by the horizontally oriented sensor. The controller of the system further automatically calibrates the end effector based on the zero vertical position determined for each of the one or more end effectors.

In another aspect of the disclosure a method includes performing the following for each link of a plurality of links of a robot within in a chamber. The method further includes causing the robot to move the link through a field of view of a vertically oriented sensor. The method further includes generating sensor data using the vertically oriented sensor as the link moves through the field of view of a vertically oriented sensor. The method further includes determining, based on the sensor data, a zero horizontal position for the link based on a position of the link at which the link was detected by the vertically oriented sensor. The method further includes automatically calibrating the robot within the chamber based on the zero horizontal position determined for each of the plurality of links.

### BRIEF DESCRIPTION OF DRAWINGS

The drawings, described below, are for illustrative purposes only and are not necessarily drawn to scale. The drawings are not intended to limit the scope of the disclosure in any way. Wherever possible, the same or like reference numbers will be used throughout the drawings to refer to the same or like parts.

FIG. 1 illustrates a schematic top view of a substrate processing system, according to embodiments of the present disclosure.

FIG. 2A illustrates a top plan view of a robot, according to embodiments of the present disclosure.

FIG. 2B illustrates a cross-sectioned side view of a robot, according to embodiments of the present disclosure.

FIG. 2C illustrates a top plan view of an additional robot, according to embodiments of the present disclosure.

FIG. 3 illustrates a top view of single end effectors of robots, according to embodiments of the present disclosure.

FIG. 4 is a flow diagram of a method associated with the automatic calibration sequence of a multi-link robot, according to embodiments of the present disclosure.

FIG. 5 illustrates the postures of a robot arm as they pass through the field of view of a sensor, according to embodiments of the present disclosure.

FIG. 6 is a flow diagram of a method associated with the automatic calibration sequence of a robot end effector within a chamber, according to embodiments of the present disclosure.

FIG. 7 is a block diagram illustrating a computer system, according to embodiments of the present disclosure.

### DETAILED DESCRIPTION

Embodiments described herein are related to joint coordinate teaching accuracy of robots. In substrate processing systems, a multi-linkage robot arm is located in the factory interface and transfers content between portions of the substrate processing system, such as enclosure systems, an aligner device, a load lock, and/or the like. A multi-linkage robot is also located in the transfer chamber and transfers content between portions of the substrate processing system, such as processing chambers, load locks, local center finding (LCF) device, sensors, and/or the like. In electronics manufacturing, it is of value to achieve rapid and precise transfer of product components (e.g., substrates such as wafers). In particular, end effectors of robots are oriented precisely relative to content that the robots transport within the manufacturing system. In some instances, improper orienting results in uneven processing and diminished quality of the substrates as a result of misaligned substrate handoffs. In some instances, robots, aligner devices, and/or LCF devices with errors cause damage to content, portions of the substrate processing system, and/or themselves. Some robots suffer from certain orientation problems as a result of joint errors introduced during joint coordinate teaching of the robot.

In multi-link robots, joint error can contribute significantly to robot inaccuracy. For example, joint kinematic error, joint hysteresis, and joint backlash are each a corresponding type of joint error that contributes to position errors experienced by multi-link robots.

Conventionally, teaching a location, calibrating, and diagnosing malfunctioning components (e.g., determining errors, speed dropping below a threshold speed, etc.) of the robot, aligner device, and/or LCF device are manual processes. For the manual process, a technician opens the substrate processing system (resulting in exposing a sealed environment within a factory interface and/or transfer chamber of the substrate processing system to atmosphere), manually handles the robot arm (potentially introducing contaminants to the robot arm), and manually performs teaching, calibration, and diagnosis. After being opened, the substrate processing system goes through a long requalification process, during which the substrate processing system is not used to process substrates. The requalification process impacts line yield, scheduling, quality, user time, energy used, and so forth.

The devices, systems, and methods disclosed herein provide improved automatic calibration of multi-linkage robot arms in semiconductor manufacturing systems. The systems and methods disclosed herein reduce or eliminate the cost of opening and venting the vacuum mainframe of a semiconductor manufacturing system by employing an automatic calibration protocol. In some embodiments, a processing device (e.g., controller of the substrate processing system) positions a robot in a plurality of postures in the substrate processing system relative to one or more sensors (e.g., one or more vertically oriented sensors and/or horizontally oriented auto teach sensors) each at a fixed location in the substrate processing system. In some embodiments one or more sensors within the chamber detect the positions for a link or end effector of the robot. In some embodiments, the robot includes multiple components, such as an end effector, a wrist member, a forearm, an upper arm, and/or the like, each of which may be calibrated using the integrated sensors.

In some embodiments, a system includes a chamber, with a robot including a plurality of links inside the chamber. In some embodiments, one or more vertically oriented sensors within the chamber detect the presence of one or more of the plurality of links as the links are moved through a field of view of the sensor(s). A controller coupled to the system may perform one of the following described actions for each of the plurality of links. The controller may cause the robot to move the link through a field of view of the vertically oriented sensor. The controller may further determine a zero horizontal position for the link based on a position of the link at which the link was detected by the vertically oriented sensor. This process may be separately performed for each of the links of the multi-link robot. The zero position may be a zeroing of a robot coordinate system to a chamber or tool coordinate system in embodiments. The controller may further automatically calibrate the robot within the chamber based on the zero horizontal positions determine for each of the plurality of links. In embodiments, the automatic calibration of the robot links by the controller are completed without the interruption of the operating conditions of the system (e.g., without opening the transfer chamber or factory interface housing the robot). For example, calibration may be performed under vacuum conditions, under heated conditions, and so on. In some embodiments, the controller may determine drift based on changes in the zero horizontal position for one or more of the plurality of links over time.

In some embodiments, the controller may further cause the robot to rotate a first link of the plurality of links about a first rotational axis to determine the zero horizontal position for the first link. The controller may subsequently cause a second link coupled to the first link at a second rotational axis to rotate about the second rotational axis while the first link is positioned at the zero horizontal position for the first link to detect the zero horizontal position for the second link. The controller may subsequently cause a third link coupled to a second link at a third rotational axis to rotate about the third rotational axis while the first link is positioned at the zero horizontal position for the first link and the second link is positioned at the zero horizontal position for the second link to detect the zero horizontal position fort the third link. This process may be performed for each link of the robot.

In some embodiments, a system includes a chamber, with a robot including a plurality of links and one or more end effectors inside the chamber. In some embodiments, one or more horizontally oriented sensors within the chamber or within a load lock connected to the chamber detect the presence of one or more of the plurality of links and/or the end effectors. A controller coupled to the system may perform one of the following described actions for each of a plurality of end effectors of the robot. The controller may cause the robot to extend the end effector. The controller may further cause the robot to move vertically to cause the extended end effector to move through field of view of the horizontally oriented sensor. The controller may further determine a zero vertical position for the end effector based on a vertical position of the robot at which the end effector was detected by the horizontally oriented sensor. This process may be repeated for each of the end effectors of the robot. The controller may further automatically calibrate the end effectors based on the zero vertical position determined for each of the one or more end effectors. In some embodiments, the controller may further determine the droop of an end effector based on a change in the zero vertical position after recalibration. In some embodiments, the controller may measure a frequency response of the end effector based on causing the end effector to perform a vertical movement and measuring an oscillation of the end effector caused by the vertical movement using the sensor data. In some embodiments, the controller may determine a system wear based on changes in the frequency response of the end effector.

In some embodiments, the controller may automatically determine at least one of a presence of a substrate disposed on the end effector, a thickness of the substrate, a material of the substrate, a warpage of the substrate, or a profile of the substrate based on the sensor data.

The systems and methods described herein have advantages over conventional solutions. The calibration for the components of the substrate processing system are determined automatically, without opening of the substrate processing system and without a subsequent requalification process of the substrate processing system (e.g., enables performance of the operations while maintaining a sealed environment). Maintaining a sealed environment prevents harmful gases from exiting the substrate processing system, prevents contamination from entering the substrate processing system, and maintains an inert environment and/or vacuum level within corresponding portions of the substrate processing system. Additionally, maintaining a sealed environment enables calibration to be performed under operating conditions, which may cause calibration values to be different from calibration values determined at conditions other than operating conditions (e.g., at atmospheric pressure). Calibration of specific components are determined to improve auto teaching and diagnosis (e.g., of the specific components, of the robot, of the aligner, of a local center finder (LCF) device, of the substrate processing system, etc.). This enables the robot to be controlled to remove content and place content in specific locations and enables the aligner device and LCF device to more accurately align content. In doing so, this reduces errors in processing content and reduces damage to the robots, enclosure systems, and/or the substrate processing system. The solutions described herein have less impact on line yield, scheduling, quality, user time, energy used, and so forth than conventional solutions.

Embodiments enable the capability of automatically aligning the X, Y and Z coordinate system of a vacuum mainframe robot to a mainframe coordinate system using sensors integrated onto the mainframe. Embodiments also enable the capability to automatically calibrate (or teach) the vacuum mainframe robot's end-effector z position in the mainframe's load lock chamber using sensors integrated onto the mainframe or load lock. In embodiments, calibration of a mainframe robot is performed without use of fixtures for robot zeroing and alignment. Instead, calibration is performed using “auto-teach” sensors integrated into the mainframe and software algorithms and programmed sequences in embodiments.

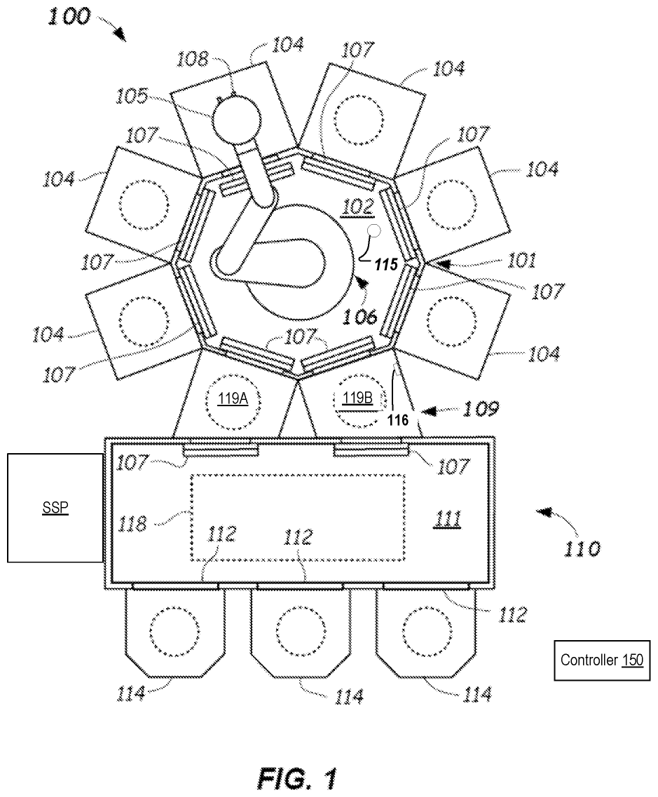

FIG. 1 illustrates a top, schematic diagram of a processing system 100 (e.g., an electronic device processing apparatus, a substrate processing system). The processing system 100 transfers content (e.g., substrates, process kit rings, carriers, validation wafers, components, etc.) between different portions of the processing system 100. The processing system 100 is adapted to process substrates 105 (e.g., 300 mm or 450 mm silicon-containing wafers, silicon plates, or the like) by imparting one or more processes thereto (e.g., via one or more process chambers 104). The processes include degassing, cleaning, pre-cleaning, deposition such as chemical vapor deposition (CVD), physical vapor deposition (PVD), atomic layer deposition, coating, oxidation, nitration, etching, polishing, lithography, and/or the like. In some embodiments, the processing system 100 includes process chambers 104 that include one or more of etch chambers, deposition chambers (including atomic layer deposition, chemical vapor deposition, physical vapor deposition, or plasma enhanced versions thereof), anneal chambers, and/or the like.

The depicted processing system 100 includes a mainframe housing 101 including a transfer chamber 102 formed therein. The transfer chamber 102 is formed by a lid (removed for illustration purposes), a bottom, and side walls, and is maintained at a vacuum in some embodiments, for example. The mainframe housing 101 includes any suitable shape, such as square, rectangular, pentagon, hexagon, heptagon, octagon (as shown), or other geometric shapes. In the depicted embodiment, a robot 106, such as a multi-arm robot (also referred to as a multi-linkage robot), is positioned at least partially inside of the transfer chamber 102. The robot 106 is adapted to be operable therein to service various chambers (e.g., one or more process chambers 104 and/or one or more load lock chambers 109) arranged around the transfer chamber 102. The transfer chamber 102 depicted in FIG. 1 is coupled to six process chambers 104 and two load lock chambers 109. However, other numbers of process chambers 104 and load lock chambers 109 are used in other embodiments.

The robot 106 is adapted to pick and place content, such as substrates 105 (sometimes referred to as “wafers” or “semiconductor wafers”), mounted on the end effector 108 (sometimes referred to as a “blade”) of the robot 106 to or from destinations through one or more slit valve assemblies 107. In the depicted embodiment of FIG. 1, the robot 106 is any suitable multi-arm robot that has sufficient mobility to transfer substrates 105 between the various process chambers 104 and/or the load lock chambers 109.

In the depicted embodiment of FIG. 1, the robot 106 is shown located and housed in a transfer chamber 102. However, it should be recognized that this embodiment of the robot 106, as well as the other robots described herein, are used in other areas of electronic device manufacturing, such as in electronic front end module (EFEM) 110 (e.g., factory interface) where the robot transports content (e.g., substrates 105) between load ports of substrate carriers 114 (e.g., enclosure systems, FOUPs, etc.) and load lock chambers 109, for example. The robot 106 described herein is also capable of other transporting uses.

The load lock chambers 109 are adapted to interface with an interface chamber 111 of the EFEM 110 (also referred to as a factory interface). The EFEM 110 receives content (e.g., substrates 105) from substrate carriers 114, such as front opening unified pods (FOUPs) docked at load ports 112. A robot 118 (load/unload robot, factory interface robot, atmospheric robot, EFEM robot, etc.) (shown dotted) is used to transfer substrates 105 between the substrate carriers 114 and the load lock chambers 109. In some embodiments, the robot 118 has the same or similar components (e.g., end effector 108, etc.) and functionalities as the robot 106. Slit valve assemblies 107 are provided at some or all of the openings into the process chambers 104 and also at some or all of the openings of the load lock chambers 109.

Robot 118 includes a robot arm, such as a selective compliance assembly robot arm (SCARA) robot. Examples of a SCARA robot include a 2 link SCARA robot, a 3 link SCARA robot, a 4 link SCARA robot, and so on. The robot 118 includes an end effector 108 on an end of the robot arm. The end effector 108 is configured to pick up and handle specific objects, such as substrates. Alternatively, or additionally, the end effector 108 is configured to handle objects such as a calibration substrate, process kit rings (edge rings), and/or substrates. The robot 118 has one or more links or members (e.g., wrist member, upper arm member, forearm member, etc.) that are configured to be moved to move the end effector 108 in different orientations and to different locations. The illustrated robot 118 includes a single end effector. However, it should be understood that the robot 118 may have any number of end effectors (e.g., 2 end effectors, 3 end effectors, 4 end effectors, 5 end effectors, etc.). In some embodiments, each of the end effectors is part of a distinct link (e.g., wrist member), where each of the wrist members are attached to the same link (e.g., to the same upper arm or forearm), and optionally at a same rotational axis. Alternatively, different end effectors may be parts of links (e.g., wrist members) that are attached to different links (e.g., to different upper arms or forearms). For example, a robot may include a single upper arm, 2 forearms, and a wrist member (and associated end effector) attached to each of the forearms. In another example, a robot may include a single upper arm, 2 forearms, and two wrist members (and associated end effectors) attached to each of the forearms. In another example, a robot may include two upper arms, a forearm attached to each of the upper arms, and one or more wrist members (and associated end effector) attached to each of the forearms.

In embodiments, one or more joints or links of the robot include one or more sensors used to determine positions of the links. The sensors of the links/joints may include optical encoders in embodiments. The optical encoders may be used to generate joint position measurements, which may be used for servo feedback control of the links.

The robot 118 is configured to transfer objects between substrate carriers 114 (e.g., cassettes, FOUPs) (or load ports), load locks 119A, 119B, SSP, aligner device, and/or the like. While conventional systems are associated with opening of (e.g., disassembly of, breaking the seal of, contaminating, etc.) a processing system (e.g., EFEM) by an operator to determine error values and perform corrective actions for (e.g., teach, calibrate, and/or diagnose malfunctioning of) a robot (e.g., of factory interface robot), the processing system 100 is configured to facilitate determining of error values and performing of corrective actions (e.g., automatic teaching, calibrating, and/or diagnosis) without opening of (e.g., disassembly of, breaking the seal of, contaminating, etc.) the processing system 100 by an operator. Accordingly, in embodiments a sealed environment including an interior volume of a transfer chamber 102 and/or an internal volume of the EFEM 110 are maintained during calibration or recalibration of robots. Embodiments are discussed with reference to calibrating robot 106 in transfer chamber 102. However, it should be understood that similar techniques may also be applied to calibrate robot 118 of EFEM 110. Accordingly, any discussion of calibration of a transfer chamber robot herein equally applies to calibration of an EFEM robot.

In some embodiments, the robot 106 is substantially similar to the robot 118. In some embodiments, the robot 106 is a SCARA robot, but has fewer links and/or fewer degrees of freedom than the robot 118.

Content, such as substrates 105, are received into the transfer chamber 102 from the EFEM 110 and also exit the transfer chamber 102, to the EFEM 110, through the load lock chambers 109 that are coupled to a surface (e.g., a rear wall) of the EFEM 110. The load lock chambers 109 include one or more load locks (e.g., load locks 119A, 119B, for example). In some embodiments, load locks 119A, 119B that are included in the load lock chambers 109 are single wafer load lock (SWLL) chambers, multi-wafer chambers, or combinations thereof, for example. Each of the substrate carriers 114 are located on a load port. In some embodiments, the load ports are directly mounted to (e.g., sealed against) the EFEM 110. Substrate carriers 114 (e.g., cassette, FOUP, process kit enclosure system, enclosure system, or the like) are configured to removably couple (e.g., dock) to the load ports. In some embodiments, one or more substrate carriers 114 are coupled to the load ports for transferring wafers and/or other substrates into and out of the processing system 100. Each of the substrate carriers 114 seal against a respective load port. In some embodiments, a first substrate carrier 114 is docked to a first load port.

In some embodiments, a load port includes a front interface that forms a vertical opening (or a substantially vertical opening). The load port additionally includes a horizontal surface for supporting a substrate carrier 114 (e.g., cassette, enclosure system, FOUP, etc.). Each substrate carrier 114 (e.g., FOUP of wafers, process kit enclosure system) has a front interface that forms a vertical opening. The front interface of the substrate carrier 114 is sized to interface with (e.g., seal to) the front interface of the load port (e.g., the vertical opening of the substrate carrier 114 is approximately the same size as the vertical opening of the load port). The substrate carrier 114 is placed on the horizontal surface of the load port and the vertical opening of the substrate carrier 114 aligns with the vertical opening of the load port. The front interface of the substrate carrier 114 interconnects with (e.g., is clamped to, is secured to, is sealed to) the front interface of the load port. A bottom plate (e.g., base plate) of the substrate carrier 114 has features (e.g., load features, such as recesses or receptacles, that engage with load port kinematic pin features, a load port feature for pin clearance, and/or an enclosure system docking tray latch clamping feature) that engage with the horizontal surface of the load port. The same load ports are used for different types of substrate carriers 114 (e.g., FOUP, process kit enclosure system, cassettes that contain wafers, etc.).

In some embodiments, the processing system 100 also includes first vacuum ports (e.g., slit valve assemblies 107 between the load locks 119 and the EFEM 110) coupling the EFEM 110 to respective load locks 119 (e.g., degassing chambers). Second vacuum ports (e.g., slit valve assemblies 107 between the load locks 119 and the transfer chamber 102) are coupled to respective load locks 119 (e.g., degassing chambers) and are disposed between the load locks 119 and transfer chamber 102 to facilitate transfer of substrates 105 and content (e.g., process kit rings, calibration disc, etc.) into the transfer chamber 102. In some embodiments, processing system 100 includes and/or uses one or more load locks 119 and a corresponding number of vacuum ports (e.g., slit valve assemblies 107) (e.g., a processing system 100 includes a single load lock 119, a single first slit valve assembly 107, and a single second slit valve assembly 107).

The transfer chamber 102 includes process chambers 104 (e.g., four process chambers 104, six process chambers 104, etc.) disposed therearound and coupled thereto. The process chambers 104 are coupled to the transfer chamber 102 through respective ports 107, such as slit valves or the like.

In some embodiments, the EFEM 110 is at a higher pressure (e.g., atmospheric pressure) and the transfer chamber 102 is at a lower pressure (e.g., vacuum). Each load lock 119 (e.g., degassing chamber, pressure chamber) has a first door (e.g., first slit valve assembly 107) to seal the load lock 119 from the EFEM 110 and a second door (e.g., second slit valve assembly 107) to seal the load lock 119 from the transfer chamber 102. Content is to be transferred from the EFEM 110 into a load lock 119 while the first door is open and the second door is closed, the first door is to close, the pressure in the load lock 119 is to be reduced to match the transfer chamber 102, the second door is to open, and the content is to be transferred out of the load lock 119. An LCF device is to be used to align the content in the transfer chamber 102 (e.g., before entering a process chamber 104, after leaving the process chamber 104).

A controller 150 controls various aspects of the processing system 100. The controller 150 is and/or includes a computing device such as a personal computer, a server computer, a programmable logic controller (PLC), a microcontroller, and so on. The controller 150 includes one or more processing devices, which, in some embodiments, are general-purpose processing devices such as a microprocessor, central processing unit, or the like. More particularly, in some embodiments, the processing device is a complex instruction set computing (CISC) microprocessor, reduced instruction set computing (RISC) microprocessor, very long instruction word (VLIW) microprocessor, or a processor implementing other instruction sets or processors implementing a combination of instruction sets. In some embodiments, the processing device is one or more special-purpose processing devices such as an application specific integrated circuit (ASIC), a field programmable gate array (FPGA), a digital signal processor (DSP), network processor, or the like. In some embodiments, the controller 150 includes a data storage device (e.g., one or more disk drives and/or solid state drives), a main memory, a static memory, a network interface, and/or other components. In some embodiments, the controller 150 executes instructions to perform any one or more of the methods or processes described herein. The instructions are stored on a computer readable storage medium, which include one or more of the main memory, static memory, secondary storage and/or processing device (during execution of the instructions). The controller 150 receives signals from and sends controls to robot 118 and robot 106 in some embodiments.

One or more sensors within the processing system 100 allow for determining error values and performing corrective actions (e.g., teaching, calibrating, and/or diagnosing) of one or more links and/or end effectors or robot 106 and/or robot 118 of the processing system 100 without opening the sealed environment within the EFEM 110 and/or transfer chamber 102 and/or adjacent chambers. In embodiments, the one or more sensors include a vertically oriented sensor 115 in transfer chamber 102. In some embodiments, the one or more sensors include a horizontally oriented sensor 118 in one or more load locks 119A-B. In some embodiments, the one or more sensors include a vertically oriented sensor within EFEM 111 (not shown). In some embodiments, sensor 115 and/or sensor 116 includes an emitter and a detector. The sensor may be, for example, a through-beam optical sensor. The through-beam optical sensor may include one or more fiber optic cables to direct a beam of light output by the emitter to a target location in embodiments. Additionally, or alternatively, the through-beam optical sensor may include one or more fiber optic cables to receive the beam of light output by the emitter and to direct the beam of light to the detector. In some embodiments, the emitter may be, for example, a laser emitter that outputs a laser beam. In other embodiments, the emitter may be or include a light-emitting diode (LED) driver and/or amplifier. The detector may include an optical detector such as one or more photodiode, a complementary metal oxide semiconductor (CMOS) sensor, a charge coupled device (CCD) sensor, and so on. In some embodiments, the detector may receive the light output of the emitter, and depending on whether or not the light output is received by the detector a presence of an object in the field of view of the sensor may be determined. For example, in some embodiments the detector may ordinarily receive the light output, and when the light output is not received, a determination can be made that an object is interposed between the emitter and detector (or between a combined emitter/detector and a reflector that ordinarily reflects the light output (e.g. laser beam) from the laser back to the detector). In some embodiments, an object is detected when the detector receives the light output. For example, an object to be detected may include a reflector on the object, which may reflect the light output by the emitter to the detector when the object is placed in the field of view of the sensor.

In embodiments, controller 150 may cause robot 106 to move one or more links of the robot through one or a series of predefined motions (e.g., between a series of predefined positions). Moving the links through the series of predefined motions may cause the link(s) of the robot arm to pass through the field of view of the vertical sensor 115. Controller 150 may record robot link positions at which the one or more links are detected by the vertical sensor 115, and based on this information may determine a zero position for each of the links and ultimately calibrate the robot 106 within transfer chamber 102. This process may be performed periodically to make sure that the robot maintains calibration, to detect drift of any of the links of the robot, and so on. Similarly, controller 150 may cause one or more end effectors of robot 106 to extend into load lock 116 and move vertically across a field of view of horizontal sensor 116. Controller 116 may record robot vertical positions at which one or more extended end effectors are detected and may determine zero vertical positions of the end effector(s) based on the detected vertical positions. In this manner, controller 150 may perform automatic horizontal calibration or robot links and vertical calibration of end effectors of robot 106. A similar process may be performed for robot links and/or end effectors of robot 118 of EFEM 110 in embodiments.

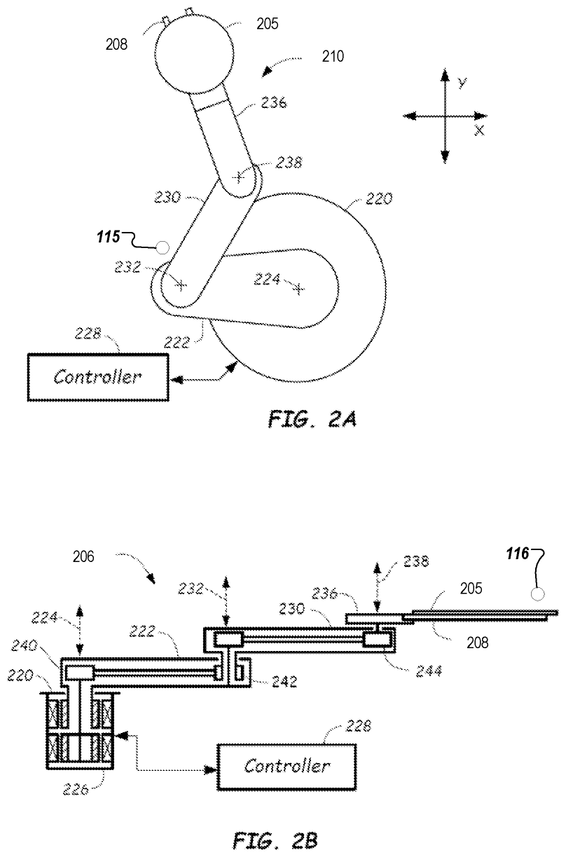

Reference is made to FIG. 2A, which illustrates a top plan view of a robot 210 (e.g., robot 106 and/or robot 118 of FIG. 1), according to certain embodiments. Reference is also made to FIG. 2B, which illustrates a cross-sectioned side view of a robot 210 (e.g., robot 106 and/or robot 118 of FIG. 1), according to certain embodiments. In the illustrated example, the links includes sides having a straight edge profile. In other examples, link side wall may not be a straight edge as depicted in the figures and it may have curvature, a convex feature and/or a concave feature. Link shapes may be complex and may or may not have special purpose protruding features with strict tolerances intended for accurately locating the joint position of the link. A link may contain recesses or cavities such as a thru hole within the link, or an imprinted surface feature such as a fiducial that is easily recognized by an imaging sensor, for example. These special purpose features may be used to accurately locate a centerline of the link.

In some embodiments, the robot 210 includes a base 220 adapted to be attached to a wall or floor of the processing system. In some embodiments, the robot 210 also includes a first link 222 (e.g., an upper arm), which, in the depicted embodiments, is a substantially rigid cantilever beam. The first link 222 is adapted to be rotated about a first rotational axis 224 in clockwise and counterclockwise rotational directions. The rotation about first rotational axis 224 is provided by any suitable motor, such as a variable reluctance or permanent magnet electric motor. The motor is received in a motor housing 226. The rotation of the first link 222 is controlled by suitable commands to the motor from a controller 228.

A second link 230 (e.g., a forearm) is coupled to the first link 222 at a second rotational axis 232. The second rotational axis 232 is spaced from the first rotational axis 224. The second link 230 is adapted for rotation in the X-Y plane relative to the first link 222 about the second rotational axis 232. A third link 236 (e.g., a wrist member) is coupled to the second link 230 at a third rotational axis 238. The third link 236 is adapted for rotation in the X-Y plane about the third rotational axis 238. The end effector 208 is coupled to the third link 236 and is adapted to carry and transport a substrate 205. While only a single third link (e.g., wrist member) 236 is shown connected to the second link, in embodiments, multiple different wrist members (e.g., a fourth link, a fifth link, etc.) may additionally be connected to the second link. Each of the wrist members may be separately rotatable about the third rotational axis 238. Additionally, it should be understood that embodiments described herein with reference to a robot arm including three links (e.g., an upper arm, forearm, and one or more wrist members) also apply to robot arms that include different numbers of links. For example, some robot arms may include a fourth link that is rotatable about a fourth rotational axis that connects the fourth link to the third link. Alternatively, the robot arm may not include a third link, and second link may include an end effector.

FIG. 2B illustrates a cross-sectioned side view of robot 210, according to certain embodiments. The robot 210 includes a plurality of joints (e.g., rotary joints) between the links or arms of the robot 206. The joints enable the arms to rotate relative to one another. Play within the joints causes inaccuracies in determining the actual position of the end effector 208 and content substrate 205 located thereon.

Each of the first link 222, second link 230 and third link 236 may be considered separate links of robot 210. In embodiments, each of these links should be calibrated by a controller 228, which may correspond to controller 150 of FIG. 1.

The robot 210 depicted in FIGS. 2A-B includes three joints or links. A first joint 240 is located between the motor housing 226 and the first link 222. The first joint 240 enables the first link 222 to rotate relative to the motor housing 226 about the first rotational axis 224. A second joint 242 is located between the first link 222 and the second link 230. The second joint 242 enables the second link 230 to rotate relative to the first link 222 about the second rotational axis 232. A third joint 244 is located between the second link 230 and the third link 236. The third joint enables the third link 236 to rotate relative to the second link 230 about the third rotational axis 238.

In some embodiments, robot 210 of FIGS. 2A-B is positioned in different postures in a substrate processing system relative to a fixed location in the substrate processing system. In particular, in embodiments controller 228 causes each of the first link 222, second link 230 and third link 236 to rotate through a field of view of vertically oriented sensor 115. Vertically oriented sensor 115 may detect the robot links as they are moved through the field of view of the sensor 115. In some embodiments, the vertically oriented sensor 115 may include a laser emitter to emit a vertical light beam and a receiver to receive the vertical light beam (not pictured). In other embodiments, the vertically oriented sensor 115 may emit an LED output. The sensor 115 may detect the link based on the vertical light beam being received by the receiver or not being received by the receiver. For example, if the link breaks the beam (causes the beam not to be received by the detector), then the link may be detected. In other embodiments, the vertically oriented sensor 115 includes an imaging sensor (e.g., a camera). Examples of imaging sensors include charge coupled device (CCD) sensors and complementary metal oxide silicon (CMOS) sensors. The imaging sensor may capture images of the link in question and the controller 228 may determine the robot position that corresponds to a zero horizontal position based on the captured images and the robot link positions in the captured images.

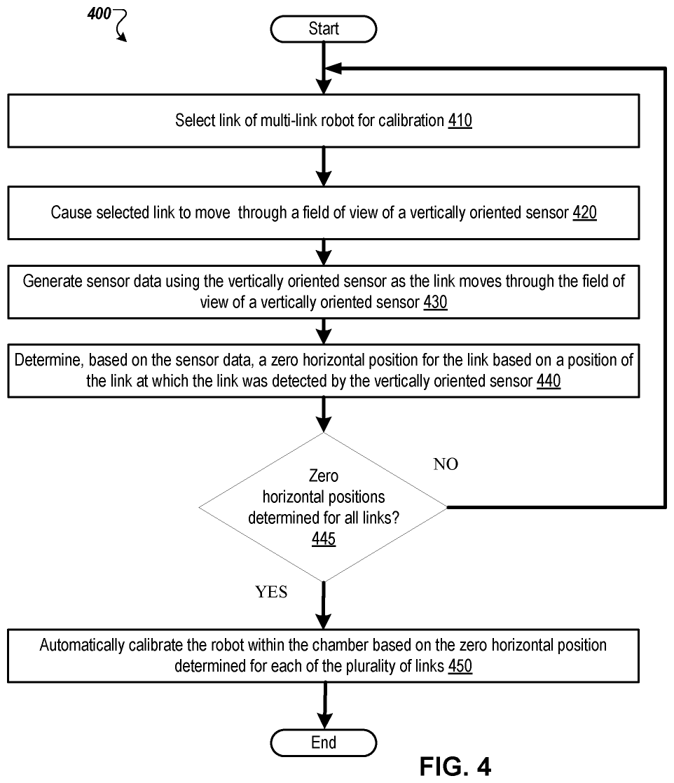

Controller 228 may determine positions of each of the links as those links were detected by sensor 115. Based on this information, controller may determine zero positions for each of the links. Controller 228 may determine positions of links from the optical encoders and “auto teach” sensors, which may be synchronous and time sensitive. Optical encoder position measurements may be used for servo feedback control of robot links, whereas the “auto teach” link position measurement may be used for Zeroing as described in greater detail below with reference to FIG. 4. In embodiments, sensor data transmission from one or more link joint position sensors (e.g., optical encoders) and/or an “auto teach” sensor (e.g., sensor 115) is synchronous and time sensitive.

The methods and illustrative examples described herein are not inherently related to any particular method of sensor data transmission between sensor 115 and controller 228. Sensor data interface to the controller 228 may be industrial interfaces where sensors are directly connected to analog or digital channels of controller 228. Alternatively, the sensor interface may be an industrial field bus including distributed input/output modules (nodes) on a network. On a field bus, various methods are available for time synchronization between distributed input/output modules and controllers, for example link joint feedback sensors (e.g., optical encoders), “auto teach” sensors and the controller 228. On a field bus, the data transmission method may be real-time and deterministic with guaranteed latency. Alternatively, the data transmission method between sensors and controller may be streaming with lossless buffering. Additionally, the sensor data transmission may occur on a wired or wireless network. Additionally the sensor modules on a field bus may be distributed across multiple isolated networks on the processing tools (not necessarily on a single network). Software applications are able to process the sensor data across multiple isolated networks in embodiments. The resulting sensor to controller time synchronization accuracy may range from nanoseconds to milliseconds in embodiments.

In embodiments, controller 228 first causes robot 210 to sweep upper arm 222 through the field of view of sensor 115 to determine a zero position of upper arm 222. Then upper arm 222 may be placed at the determined zero position for the upper arm 222. While the upper arm 222 is at its determined zero position, forearm 230 may be swept through the field of view of sensor 115, and based on the position(s) of forearm 230 at which it was detected controller 228 may determine a zero position of forearm 230. Forearm 230 may then be placed at its zero position while upper arm 222 is also placed at its zero position while wrist member 236 is swept through the field of view of sensor 115 to determine the zero horizontal position of wrist member 236. Once the horizontal zero positions of each of the links of robot 210 are determined, the x-y positioning of each of the links may be calibrated relative to the sensor 115 and to a chamber containing robot 210. In some embodiments, the robot 210 may move the first link 222 through the field of view of the sensor 115 causing the robot to sweep the first link 222 through one or more arcs that cause the link to pass through the field of view of the sensor 115.

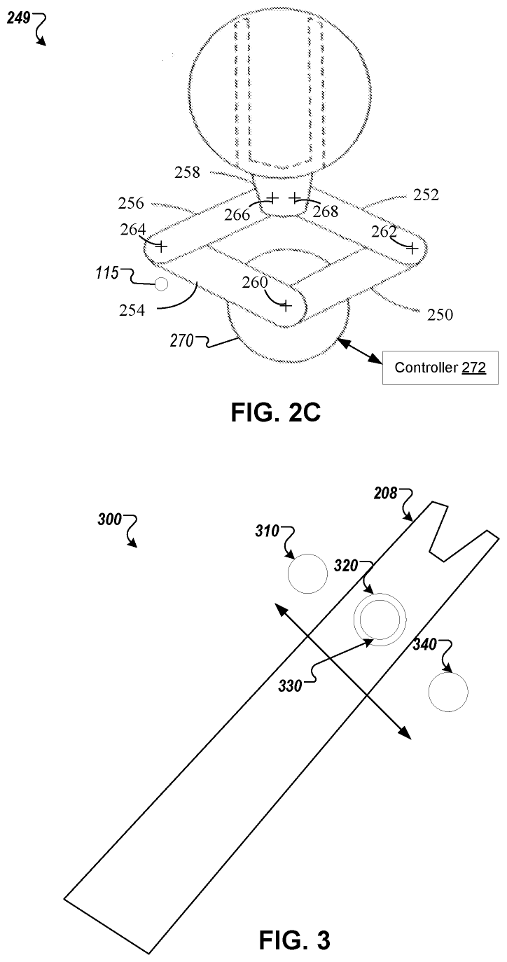

In some embodiments, third link 236 may include an end effector 208 for the robot 210, and the zero horizontal position for the third link is determined based on identifying a center of the end effector 208, as is descried with reference to FIG. 3.

The illustrated robot 210 includes a single end effector. However, it should be understood that the robot 210 may have any number of end effectors (e.g., 2 end effectors, 3 end effectors, 4 end effectors, 5 end effectors, 6 end effectors, 7 end effectors, 8 end effectors, etc.). In some embodiments, each of the end effectors is part of a distinct link (e.g., wrist member), where each of the wrist members are attached to the same link (e.g., to the same upper arm or forearm), and optionally at a same rotational axis. For example, 2, 3 or more wrist members (and associated end effectors) may all be attached to a same forearm. Alternatively, different end effectors may be parts of links (e.g., wrist members) that are attached to different other links (e.g., to different upper arms and/or forearms). For example, a robot may include a single upper arm, 2 forearms attached to the upper arm at a rotational axis, and a wrist member (and associated end effector) attached to each of the forearms at respective rotational axes. In another example, a robot may include a single upper arm, 2 forearms attached to the upper arm at a rotational axis, and two wrist members (and associated end effectors) attached to each of the forearms at respective rotational axes. In another example, a robot may include two upper arms each having a different rotational axis or sharing a same rotational axis, a forearm attached to each of the upper arms at a respective additional rotational axis, and one or more wrist members (and associated end effector) attached to each of the forearms at a respective further rotational axis. The calibration of such alternative robot designs would be performed in the same manner as set forth above. Each of the links would be swept through the field of view of the vertical sensor one at a time. As a horizontal zero position is determined for a link, that link may be set to its determined zero horizontal position while a next link is swept through the field of view of the vertical sensor. This process may be repeated for each link until the zero horizontal position has been determined for each of the links.

In a similar manner, once each of the links of the robot are calibrated in the x-y plane, the vertical zero positions of each of the end effectors of the robot 210 may be determined and used to calibrate the vertical positioning of the end effectors. In embodiments, controller 228 causes robot 210 to extend an end effector to be calibrated, and causes the robot to move the end effector vertically through a field of view of horizontally oriented sensor 116. The horizontally oriented sensor may include a laser-based sensor, an LED-based sensor, an imaging sensor, and/or other type of sensor. Controller 228 may determine a vertical position or positions at which the end effector is detected by horizontally oriented sensor 116, and based on such vertical position(s), controller may determine a zero vertical position for the end effector. This process may be repeated for each end effector of the robot 210.

In embodiments, sensor data is generated that identifies the fixed location(s) of links and/or end effectors of the robot 210 relative to the transfer chamber, load lock chamber, sensor(s), etc. Based on the sensor data, error values may be determined corresponding to one or more links and/or end effectors of the robot 210 and, based on the error values, performance of one or more corrective actions associated with the one or more links and/or end effectors may be performed. In some embodiments, the error values and the corrective actions correspond to joint rotation and/or vertical positions for one or more links and/or end effectors of the robot 210. In some embodiments, the controller 228 determines each error value for each component separately (e.g., by isolating movement of each component), and based on the error value determines a new zero horizontal zero value and/or vertical zero value for one or more links and/or end effectors of the robot 210.

FIG. 2C illustrates a top plan view of an additional robot 249, according to embodiments of the present disclosure. In embodiments, robot 249 is a parallel arm robot having multiple arms or links that couple to a same end effector, also referred to as a “frog leg” robot. In the illustrated example, the links include sides having a straight edge profile. In other examples, link side walls may not be a straight edge as depicted in the figures and may have curvature, a convex feature and/or a concave feature. Link shapes may be complex and may or may not have special purpose protruding features with strict tolerances intended for accurately locating the joint position of the link. A link may contain recesses or cavities such as a thru hole within the link, or an imprinted surface feature such as a fiducial that is easily recognized by an imaging sensor, for example. These special purpose features may be used to accurately locate a centerline of the link.

In some embodiments, the robot 249 includes a base 270 adapted to be attached to a wall or floor of the processing system. In some embodiments, the robot 249 also includes a first link 250 (e.g., a first upper arm) and a second link 254 (e.g., a second upper arm). The first link 250 is adapted to be rotated about a first rotational axis 260 in clockwise and counterclockwise rotational directions. Similarly, the second link 254 is adapted to be rotated about first rotational axis 260 in clockwise and counterclockwise rotational directions. In some embodiments, first link and second link may rotate about different rotational axes. The rotation of first link 250 about first rotational axis 260 is provided by a first motor, and the rotation of second link 254 about first rotational axis 260 is provided by a second motor. The rotation of the first link 250 and of the second link are controlled by suitable commands to the motor from a controller 272, which may correspond to controller 150 of FIG. 1 in some embodiments.

A third link 252 (e.g., a first forearm) is coupled to the first link 250 at a second rotational axis 262. Similarly, a fourth link 256 (e.g., a second forearm) is coupled to the second link 254 at a third rotational axis 264. The second rotational axis 262 and third rotational axis 264 are spaced from the first rotational axis 260 and from each other. The third link 252 is adapted for rotation in the X-Y plane relative to the first link 250 about the second rotational axis 262, and the fourth link 256 is adapted for rotation in the X-Y plane relative to the second link 254 about the third rotational axis 264.

A fifth link 258 (e.g., a wrist member) may be coupled to the third link 252 at a fourth rotational axis 268 and to the fourth link 256 at a fifth rotational axis 266. Alternatively, the fifth link 258 may be coupled to the third link 252 and to the fourth link at a same rotational axis. In some embodiments, third link 252 and fourth link 256 are not associated with their own motors, and are instead automatically moved responsive to movement of first link 250 and/or a second link 254. Similarly, fifth link 258 may not be associated with its own motor, and may instead automatically be moved responsive to movement of the third link 252 and fourth link 256, caused by the movement of the first link 250 and/or a second link 254.

Fifth link 258 may include an end effector, which may extend or retract based on controlled rotation of first link 250 and/or second link 254. In embodiments, rotation of first link 250 and second link 254 in a same direction and amount causes the relation between the first link 250 and second link 254 to remain unchanged, which causes all of the links to rotate together, and for the fifth link 258 to remain at a same radial distance from rotational axis 260. Rotation of first link 250 and second link 254 towards each other causes the fifth link 258 and attached end effector to extend, and rotation of the first link 250 and second link 254 away from each other causes the fifth link 258 and attached end effector to retract.

It should be understood that embodiments described herein with reference to robot 249 also apply to robot arms that include different numbers of links and/or end effectors. For example, some robot arms may include one or more additional pairs of parallel links that together control extraction and retraction of one or more additional end effectors. For example, a sixth link may be connected to first link 250 at a sixth rotational axis near second rotational axis 262, and a seventh link may be connected to second link 254 at a seventh rotational axis near third rotational axis 264. An eighth link that includes an additional end effector may then be connected to both the sixth and seventh links at one or more additional rotational axes. In some embodiments, the eighth link is directed 180 degrees from fifth link 258, and an end effector of the eighth link points directly opposite the end effector of fifth link 258. In another example, fifth link 258 may include multiple end effectors (e.g., two or more parallel end effectors) attached thereto, which may extend and retract in unison in embodiments.

In embodiments, one or more of the links and/or the end effector of robot 249 may be calibrated (e.g., horizontal zero positions of the links and/or end effector may be determined) in the same manner as described herein with reference to robot 210. For example, first link 250 may be rotated such that it passes through a field of view of vertically-oriented sensor 115 to determine a zero horizontal position of the first link 250. Similarly, second link 254 may be rotated such that it passes through the field of view of vertically-oriented sensor 115 to determine a zero horizontal position of the second link 254. In some embodiments, first and second links 250, 254 are rotated together (e.g., both rotated clockwise and/or counterclockwise) to move the first link 250 and/or second link 254 through the field of view of the sensor 115. Alternatively, first link 250 may be moved without also moving second link 254 and/or the second link 254 may be moved without also moving the first link 250 to generate measurements of first link 250. In some embodiments, first link 250 and second link 254 are moved together to cause a link to be measured to be positioned near sensor 115. Once the link to be measured is in position, then that link may be rotated without also rotating the other link. This would cause the relative position of the link being measured to change with respect to the link not being measured, which would in turn cause the end effector and fifth link 258 to extend or retract during measurement of the first or second link. Once zero horizontal positions of the first and second link are determined, the zero positions for the third and/or fourth links may be determined. This may include moving both the first and second links in such a manner to cause third link 252 to pass through the field of view of the sensor 115, and similarly moving both the first and second links in such a manner to cause fourth link 256 to pass through the field of view of the sensor 115. Similarly, the zero horizontal position of fifth link 258 and/or its end effector may be determined by moving both the first and second links in such a manner to cause fifth link 258 and/or its end effector to pass through the field of view of the sensor 115. In some embodiments, the zero horizontal position of fifth link 258 may be determined without first determining the zero horizontal positions of third and/or fourth links.

In some embodiments, the zero horizontal position of the fifth link 258 may be determined without first determining the zero horizontal positions of any of the first through fourth links. For example, along the centerline of the end effector, the robot may rotate the first and/or second links to extend and retract the end effector to find a center hole of the end effector. Similarly, the first and/or second links may be rotated (e.g., rotated together) to cause the end effector to rotate about rotational axis 260 while maintaining a same radial distance from the rotational axis 260. Points along the edges of the center hole may be used to fit a circle and find the center of the hole. The zero position of the robot may be established by the found center point of the end effector. This process may also be performed after finding the zero positions for any of the first through fourth links. Accordingly, in some embodiments the end effector is used for establishing the zero horizontal position of robot without determining zero horizontal positions of other links of the robot, while in other embodiments the end effector is used to establish the zero horizontal position of the fifth link after finding the zero horizontal positions of other links.

Any discussion herein with reference to determining zero horizontal positions of links and/or of calibrating robots applies to parallel arm robots, such as the parallel arm robot 249 of FIG. 2C.

FIG. 3 illustrates a top view 300 of an end effector 208 of robot 210, according to embodiments of the present disclosure. In some embodiments, the end effector 208 may include a hole 320 at the center of the body of the end effector (centered between the left and right edges of the end effector) that allows for the beam of a sensor to pass through at the center of the end effector 208. In some embodiments, the position of the center of the end effector 208 is determined by the detection of the hole 320 of the end effector 208 as the end effector 208 passes between at least two stations (310, 340) and through a field of view of a sensor 320. As the end effector 208 progresses through a field of view of the sensor 320, an initial measurement of the position of the center of the end effector 208 via the hole 320 may be determined, and the position of the end effector 208 (e.g. blade) may be fully validated. In embodiments, a link position for the left and right sidewall of the hole may be determined, which may be used to compute a link position that would place center of the end effector under the field of view of the sensor. Additionally or alternatively, the end effector (which may correspond to a link of the robot arm) may be detected by detecting a left and/or right outer edge of the end effector using the sensor.

In embodiments, other tolerance features may also be included in the end effector or other link (e.g., in addition to or instead of holes). Examples of such other tolerance features include recessed features, protruding features, and fiducial marks, which may be formed on any portion of a link or end effector (e.g., on a side of a link, on a top surface of a link, within a body of a link, and so on. In some embodiments, the tolerance feature(s) may be manufactured to a greater accuracy than other portions of a link. This may enable a link zero horizontal position to be determined with increased accuracy based on using detection of the tolerance feature(s) to determine a zero horizontal position for a link. In some embodiments, the position of the a link is determined by the detection of the a tolerance feature of a link as the link passes between at least two stations and through a field of view of a sensor, using the techniques described above.

FIG. 4 is a flow diagram of a method 400 associated with the automatic calibration sequence of a multi-link robot, according to embodiments of the present disclosure. The robot may include any number of links, arranged in any configuration. In a first example, the robot may include three links and a single end effector. In another example, a robot may include a single upper arm, 2 forearms attached to the upper arm at a rotational axis, and a wrist member (and associated end effector) attached to each of the forearms at respective rotational axes. In another example, a robot may include a single upper arm, 2 forearms attached to the upper arm at a rotational axis, and two wrist members (and associated end effectors) attached to each of the forearms at respective rotational axes. In another example, a robot may include two upper arms each having a different rotational axis or sharing a same rotational axis, a forearm attached to each of the upper arms at a respective additional rotational axis, and one or more wrist members (and associated end effector) attached to each of the forearms at a respective further rotational axis. Any other multi-link robot configuration may also be calibrated according to method 400.

At block 410 a link of a multi-link robot is selected for calibration. At block 420, the selected link is caused to move through a field of view of a vertically oriented sensor. This may include rotating the link clockwise and/or counterclockwise around a vertical axis. At block 430, sensor data is generated using the vertically oriented sensor as the link moves through the field of view of the vertically oriented sensor. In some embodiments, the link is moved through the field of view of the sensor multiple times (e.g., 5 times, 10 times, 15 times, 20 times, etc.). Measurements of the detected left and/or right sides of the link may be averaged to determine robot position coordinates corresponding to the left and/or right sides of the link.

In embodiments, robot positions at which a left and/or right side of the link have been detected are determined. Based on these robot positions, a sensor position and/or a link zero position may be determined and used to calibrate the link of the robot. A controller may include a starting zero position for the link, which may be determined based on design of the robot and/or a chamber containing the robot. However, the robot and/or sensor may not have been installed at exactly the target positions and/or orientations in the chamber. Accordingly, a difference between the robot position at which the right and/or left sides of the link were detected and the initial robot position at which the right and/or left sides of the link were expected to be detected may be determined. Based on this difference, a position error of the sensor and/or of the robot (or a link of the robot) may be determined. The position error may be used to determine a position offset for the link that can be applied to set a zero horizontal position for the link of the robot. If this process is performed for a first link of the robot, then the process may be used to determine a sensor position error in addition to determining a horizontal zero position for the link.

At block 440, based on the sensor data, a zero horizontal position is determined for the link based on the position of the link at which the link was detected by the vertically oriented sensor. A sensor position error may also be determined, and used to update the sensor position. The updated sensor position may be used in determining horizontal zero positions for subsequent links.

At block 445, processing logic branches based on whether the zero horizontal positions have been determined for all links. If so, execution proceeds to block 450. If not, execution returns to block 410. At block 410, processing logic may select a next link of the robot for calibration. The link (or links) for which a horizontal zero position has already been determined may be placed at their respective horizontal zero positions. While the already measured links are placed at their respective horizontal zero positions, the currently selected link may be moved through the field of view of the vertically oriented sensor. The operations of blocks 420-440 may be repeated for each of the links of the robot until horizontal zero positions have been determined for each of the links.

In embodiments, a center position of the last link or links that includes an end effector is determined in addition to a right side wall and/or left side wall of the last link or links. In embodiments, the end effector includes a through hole at a known position within the end effector (e.g., at a position centered between the right and left side wall of the end effector). In embodiments, positions at which the sensor detects the center hole of the end effector are used to determine a center position of the link that includes the end effector. For example, a controller may cause the link to move clockwise and determine a link position at which a first inner side wall of the hole is detected, and may cause the link to move counterclockwise and determine a link position at which a second inner side wall of the hole is detected. Based on the robot link positions at which the right and left inner side walls of the hole are detected, the controller may determine the center position of the link. The center position of the link may be used to determine the horizontal zero position for that link in addition to, or instead of, the robot link positions at which the side walls of the left and right of the link are detected.

At block 450, the robot within the chamber is automatically calibrated based on the zero horizontal positions determined for each of the plurality of links. This may include determining offsets (e.g., rotational offsets) for each of the links. The determined offsets may be applied to compensate for minor errors in installation of the robot and/or of the sensor. Once the robot is calibrated, the exact positioning of the robot within a chamber (e.g., within a transfer chamber or EFEM) may be known.

In some embodiments, the controller may measure a frequency response of the end effector based on causing the one or more links of the robot to perform a horizontal rotational movement and measuring an oscillation of the end effector caused by the rotational movement using the vertically oriented sensor. The controller may further automatically calibrate the robot at one or more operating conditions. In some embodiments, the controller may periodically automatically recalibrate the robot without user input. The controller may further determine drift based on changes in the zero horizontal position for one or more of the plurality of links over time.

In some embodiments, the controller may periodically automatically recalibrate the robot without user input. For example, method 400 may be performed at initial installation and/or manufacture of a transfer chamber. Method 400 may then be periodically performed to update a calibration of the robot. By periodically performing method 400, minor changes in calibration that may occur via aging and use of the robot may be corrected. Additionally, controller may record the determined offsets and/or zero horizontal positions for each of the links determined at each calibration. The controller may compare the different zero positions/offsets determined at different times to determine whether the robot calibration is drifting, to determine whether such drift is accelerating, and so on. Based on changes in the horizontal zero positions/offsets over time, controller may predict when one or more components of the robot may fail, may proactively recommend maintenance and/or replacement of one or more parts of the robot, and so on.

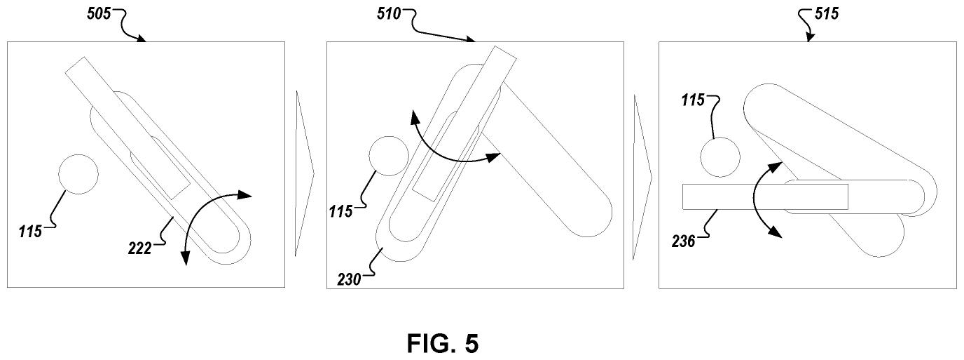

FIG. 5 illustrates the postures of a robot arm as they pass through the field of view of a sensor, according to embodiments of the present disclosure. At block 505 the first link 222 is moved through the field of view of the sensor 115. As the first link 222 passes through the field of view of the sensor 115, the beam of the sensor 115 is broken and the position of the left and right side walls of the first link 222 are determined at the link positions at which the beam was broken and/or unbroken. An offset is calculated between the link positions at which the left and right side walls the robot were detected and a preconfigured zero horizontal position for the link. This offset may be applied to the preconfigured zero horizontal position for the link to compensate for the offset.

At block 510 the second link 230 is moved through the field of view of the sensor 115 while the first link 222 is at its determined updated zero horizontal position. As the second link 230 passes through the field of view of the sensor 115, the beam of the sensor 115 is broken and the link position at which the left and right side walls of the second link 230 are detected are determined. An offset is calculated between the link positions at which the left and right side walls the robot were detected and a preconfigured zero horizontal position for the second link. This offset may be applied to the preconfigured zero horizontal position for the second link to compensate for the offset.

At block 515 the third link 236 is moved through the field of view of the sensor 115 while the first and second links are at their respective updated zero horizontal positions. As the third link 236 passes through the field of view of the sensor 115, the beam of the sensor 115 is broken and the position of the left and right side walls of the third link 236 are determined at the link positions at which the beam was broken and/or unbroken. An offset is calculated between the link positions at which the left and right side walls of the third link (or left and right inner side walls of a hole in an end effector of the third link) were detected and a preconfigured zero horizontal position for the third link. This offset may be applied to the preconfigured zero horizontal position for the third link to compensate for the offset.

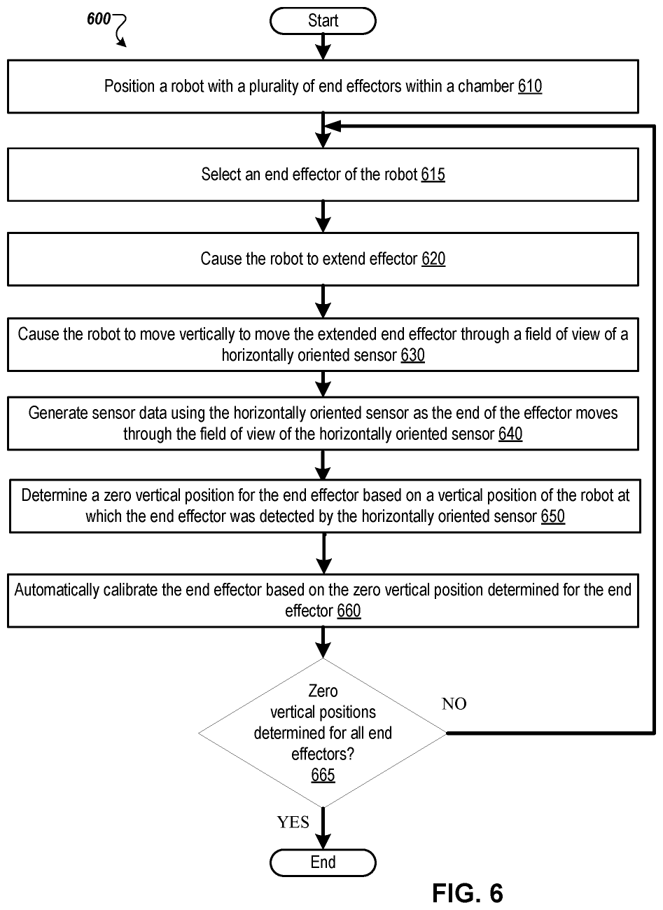

FIG. 6 is a flow diagram of a method 600 associated with the automatic calibration sequence of a robot end effector within a chamber, according to embodiments of the present disclosure. At block 610, a robot with a plurality of end effectors is positioned within a chamber. At block 615 an end effector of the robot is selected. The robot may include a single end effector or multiple end effectors.

At block 620, the robot is caused to extend the selected end effector. In embodiments, a controller causes the robot to extend the end effector into a load lock chamber. The load lock chamber may include a horizontally oriented sensor (e.g., laser and emitter, or LED output) disposed therein.

At block 630, the robot is caused to move the vertically to move the extended end effector through a field of view of the horizontally oriented sensor. At block 640, sensor data is generated using the horizontally oriented sensor as the end effector moves through the field of view of a horizontally oriented sensor. A vertical position of the robot at which the end effector is detected may be determined.

At block 650, a zero vertical position for the end effector is determined based on a vertical position of the robot at which the end effector was detected by the horizontally oriented sensor. At block 660, the end effector is automatically calibrated based on the zero vertical position determined for the end effector. Automatic calibration may include determining an offset between a vertical position at which the end effector was expected to be detected (e.g., based on a design of the mainframe, load lock and/or robot) and a vertical position at which the end effector was actually detected. This offset may be applied to correct the vertical position of the end effector for put and place operations in the load lock and/or in process chambers connected to the transfer chamber.

At block 665, the controller may determine whether zero vertical positions have been determined for all end effectors of the robot. If not, the method may return to block 615 and another end effector of the robot may be selected for calibration. If so, the method may end.

In some embodiments, the controller may periodically automatically recalibrate the robot without user input. For example, method 600 may be performed at initial installation and/or manufacture of a transfer chamber. Method 600 may then be periodically performed to update a calibration of the robot. By periodically performing method 600, minor changes in calibration that may occur via aging and use of the robot may be corrected. Additionally, controller may record the determined offsets and/or zero vertical positions for each of the end effectors determined at each calibration. The controller may compare the different zero positions/offsets determined at different times to determine whether the robot calibration is drifting, whether the end effectors have begun to droop (e.g., are no longer horizontal), to determine whether such drift is accelerating, and so on. In one embodiment, the controller determines whether a new zero vertical position of an end effector is at a higher z robot position than a previous zero vertical position. Such a higher new zero vertical position indicates that the end effector is drooping, and is at a downward angle relative to the robot arm. The difference between the previous zero vertical position and the new zero vertical position may be user to determine an angle of droop of the end effector using geometry and/or trigonometry and based on known measurements of the end effector. Based on changes in the vertical zero positions/offsets over time, controller may predict when one or more components of the robot may fail, may proactively recommend maintenance and/or replacement of one or more parts of the robot, and so on.

In some embodiments, the controller may automatically determine the presence of a substrate disposed on the end of an end effector. In some embodiments, the controller may also detect at least one of the presence of a substrate, the thickness of a substrate, the material or composition of a substrate, the warpage of the substrate, or a profile of the substrate based on one or more of the vertical robot positions at which the horizontally oriented sensor detected the substrate. For example, a substrate (e.g., a wafer) may have a known thickness. If a substrate is disposed on the end effector and the end effector is moved vertically through the field of view of the horizontal sensor, the horizontal sensor may determine the robot vertical positions corresponding to the top and bottom of the substrate. If the substrate is determined to have a thickness that is greater than a known thickness of the substrate, then the substrate may be determined to be warped.

In some embodiments, the end effector may be caused to perform a vertical movement. The vertical movement may be performed at least partially within the field of view of the horizontal sensor. The controller may measure a frequency response of the end effector, and may measure an oscillation of the end effector from this vertical movement using the horizontally oriented sensor. As a result of the movement, the end effector may oscillate at some frequency, and this frequency may be detected by the horizontal detector based on the end effector moving in and out of the field of view of the sensor according to some frequency. In some embodiments, the controller may determine system wear based on changes in the frequency response or oscillation of the end effector.

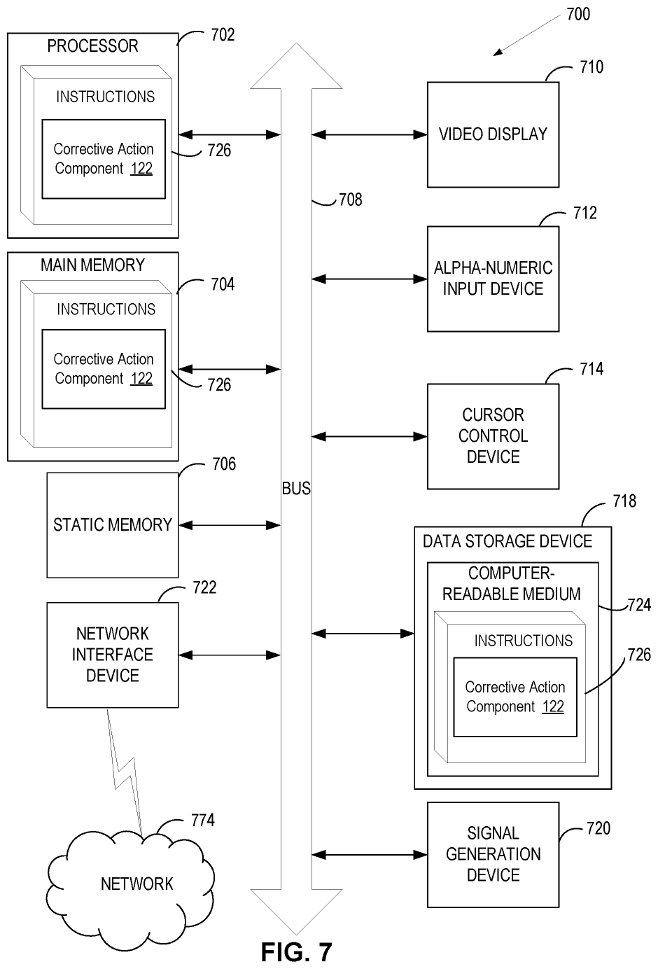

FIG. 7 is a block diagram illustrating a computer system 700, according to certain embodiments. In some embodiments, computer system 700 is one or more of controller 109 of FIG. 1 or controller 228 of FIGS. 2A-B. In some embodiments, computer system 700 includes one or more of the components and/or functionalities described in relation to FIG. 7.

In some embodiments, computer system 700 is connected (e.g., via a network, such as a Local Area Network (LAN), an intranet, an extranet, or the Internet) to other computer systems. Computer system 700 operates in the capacity of a server or a client computer in a client-server environment, or as a peer computer in a peer-to-peer or distributed network environment. Computer system 700 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 700 includes a processing device 702, a volatile memory 704 (e.g., Random Access Memory (RAM)), a non-volatile memory 706 (e.g., Read-Only Memory (ROM) or Electrically-Erasable Programmable ROM (EEPROM)), and a data storage device 716, which communicate with each other via a bus 708.

Processing device 702 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

Computer system 700 further includes a network interface device 722 (e.g., coupled to network 774). Computer system 700 also includes a video display unit 710 (e.g., an LCD), an alphanumeric input device 712 (e.g., a keyboard), a cursor control device 714 (e.g., a mouse), and a signal generation device 720.

Instructions 726 also reside, completely or partially, within volatile memory 704 and/or within processing device 702 during execution thereof by computer system 700, hence, volatile memory 704 and processing device 702 also constitute machine-readable storage media.

While computer-readable storage medium 724 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as ASICS, FPGAs, DSPs or similar devices. In addition, the methods, components, and features are implemented by firmware modules or functional circuitry within hardware devices. Further, the methods, components, and features are implemented in any combination of hardware devices and computer program components, or in computer programs.

Unless specifically stated otherwise, terms such as “positioning,” “generating,” “determining,” “causing,” “applying,” “discarding,” “providing,” “obtaining,” “receiving,” “training,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or it includes a general purpose computer system selectively programmed by a computer program stored in the computer system. Such a computer program is stored in a computer-readable tangible storage medium.

The methods and illustrative examples described herein are not inherently related to any particular computer or other apparatus. Various general purpose systems are used in accordance with the teachings described herein, or it proves convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

It should be readily appreciated that the present disclosure is susceptible of broad utility and application. Many embodiments and adaptations of the present disclosure other than those herein described, as well as many variations, modifications, and equivalent arrangements, will be apparent from, or reasonably suggested by, the present disclosure and the foregoing description thereof, without departing from the substance or scope of the present disclosure. Accordingly, while the present disclosure has been described herein in detail in relation to specific embodiments, it is to be understood that this disclosure is only illustrative and presents examples of the present disclosure and is made merely for purposes of providing a full and enabling disclosure. This disclosure is not intended to be limited to the particular apparatuses, assemblies, systems and/or methods disclosed, but, to the contrary, the intention is to cover all modifications, equivalents, and alternatives falling within the scope of the claims.

What is claimed is:

1. A system comprising:
a chamber;
a robot within the chamber, the robot comprising a plurality of links;
a vertically oriented sensor within the chamber, the vertically oriented sensor to detect a presence of one or more of the plurality of links; and
a controller to:
for each link of the plurality of links, perform the following:
cause the robot to move the link through a field of view of the vertically oriented sensor; and
determine a zero horizontal position for the link based on a position of the link at which the link was detected by the vertically oriented sensor; and
automatically calibrate the robot within the chamber based on the zero horizontal position determined for each of the plurality of links.

2. The system of claim 1, wherein the chamber comprises a transfer chamber for an electronics manufacturing system.

3. The system of claim 1, wherein the vertically oriented sensor comprises a laser emitter to emit a vertical light beam and a receiver to receive the vertical light beam, wherein the sensor is to detect the link based on the vertical light beam being received by the receiver or not being received by the receiver.

4. The system of claim 1, wherein the controller is to:
cause the robot to rotate a first link of the plurality of links about a first rotational axis to determine the zero horizontal position for the first link;
subsequently cause a second link coupled to the first link at a second rotational axis to rotate about the second rotational axis while the first link is positioned at the zero horizontal position for the first link to detect the zero horizontal position for the second link; and
subsequently cause a third link coupled to the second link at a third rotational axis to rotate about the third rotational axis while the first link is positioned at the zero horizontal position for the first link and the second link is positioned at the zero horizontal position for the second link to detect the zero horizontal position for the third link.

5. The system of claim 4, wherein the third link comprises an end effector for the robot, and wherein the zero horizontal position for the third link is determined based on identifying a center of the end effector.

6. The system of claim 1, wherein causing the robot to move the link through the field of view of the vertically oriented sensor comprises causing the robot to sweep the link through one or more arcs that cause the link to pass through the field of view of the vertically oriented sensor.

7. The system of claim 1, wherein the robot comprises one or more end effectors, the system further comprising:
a horizontally oriented sensor configured to detect a presence of the one or more end effectors;
wherein for each end effector of the one or more end effectors the controller is to:
cause the robot to extend the end effector;
cause the robot to move vertically to cause the extended end effector to move through a field of view of the horizontally oriented sensor; and
determine a zero vertical position for the end effector based on a vertical position of the robot at which the end effector was detected by the horizontally oriented sensor; and
automatically calibrate the end effector based on the zero vertical position determined for each of the one or more end effectors.

8. The system of claim 7, wherein the chamber comprises a transfer chamber, the system further comprising:
a load lock coupled to the transfer chamber, wherein the horizontally oriented sensor is positioned within the load lock.

9. The system of claim 7, wherein the controller is to automatically recalibrate the end effector, and to determine droop of the end effector based on a change in the zero vertical position after recalibration.

10. The system of claim 7, wherein the controller is to measure a frequency response of the end effector based on causing the end effector to perform a vertical movement and measuring an oscillation of the end effector caused by the vertical movement using the horizontally oriented sensor.

11. The system of claim 1, wherein the controller is to automatically calibrate the robot at one or more operating conditions.

12. The system of claim 1, wherein the controller is to periodically automatically recalibrate the robot without user input.

13. The system of claim 12, wherein the controller is to determine drift based on changes in the zero horizontal position for one or more of the plurality of links over time.

14. The system of claim 1, wherein the robot is a parallel arm robot.

15. A system comprising:
a chamber;
a robot within the chamber, the robot comprising a plurality of links and one or more end effectors;
a horizontally oriented sensor configured to detect a presence of the one or more end effectors; and
a controller to:
for each end effector of the one or more end effectors, perform the following:
cause the robot to extend the end effector;
cause the robot to move vertically to cause the extended end effector to move through a field of view of the horizontally oriented sensor; and
determine a zero vertical position for the end effector based on a vertical position of the robot at which the end effector was detected by the horizontally oriented sensor; and
automatically calibrate the end effector based on the zero vertical position determined for each of the one or more end effectors.

16. The system of claim 15, wherein the controller is to automatically recalibrate the end effector, and to determine droop of the end effector based on a change in the zero vertical position after recalibration.

17. The system of claim 15, wherein the controller is to automatically determine at least one of a presence of a substrate disposed on the end effector, a thickness of the substrate, a material of the substrate, a warpage of the substrate, or a profile of the substrate based on one or more vertical robot positions at which the horizontally oriented sensor detected the substrate.

18. The system of claim 15, wherein the controller is to measure a frequency response of the end effector based on causing the end effector to perform a vertical movement and measuring an oscillation of the end effector caused by the vertical movement using the horizontally oriented sensor.

19. The system of claim 18, wherein the controller is to determine a system wear based on changes in the frequency response for the end effector.

20. A method comprising:
for each link of a plurality of links of a robot within a chamber, perform the following:
causing the robot to move the link through a field of view of a vertically oriented sensor;
generating sensor data using the vertically oriented sensor as the link moves through the field of view of a vertically oriented sensor;
determining, based on the sensor data, a zero horizontal position for the link based on a position of the link at which the link was detected by the vertically oriented sensor; and
automatically calibrating the robot within the chamber based on the zero horizontal position determined for each of the plurality of links.
